(19) United States
(12) Patent Application Publication
(10) Pub. No.: US 2016/0001485 A1
(43) Pub. Date: Jan. 7, 2016

(54) EXTRUDER FILTER REPLACEMENT AND BACKWASH STRUCTURE

(71) Applicant: SINO-ALLOY MACHINERY INC., Kuan-Yin estate (TW)

(72) Inventor: Mei-Chuan CHEN, Kuan-Yin estate (TW)

(21) Appl. No.: 14/320,641

(22) Filed: Jul. 1, 2014

(51) Int. Cl. B29C 47/68; B01F 3/08; B01F 15/02; B29C 47/54; B01F 15/00

(52) U.S. Cl. CPC B29C 47/68; B29C 47/54; B01F 15/00974; B01F 15/0237; B01F 15/0292; B01F 3/08; B01F 2215/0049

(57) ABSTRACT

An extruder filter replacement and backwash structure includes an extruder body having a feed hole and a material outlet respectively located in opposing front and rear sides thereof, a first piston set with a first piston rod, and a second piston set with a second piston rod. Subject to cross connection between the first piston rod and second piston rod and the feed hole and material outlet of the extruder body, the first filter or second filter can be replaced without shutting down the extruder press, or backwashed during operation of the extruder press.

### BACKGROUND OF THE INVENTION

1. Field of the Invention

The invention relates to extruder technology and more particularly, to an extruder filter replacement and backwash structure, which facilitates quick replacement of filters and is capable of backwashing filters.

2. Description of the Related Art

An extruder has filters installed therein for filtering the applied material. After a period of time in application, the filters can be contaminated with impurities to hinder the delivery of the applied material. Therefore, the filters of an extruder must be regularly replaced. However, when replacing the filters, the extruder must be shut down, resulting in machine capacity loss.

### SUMMARY OF THE INVENTION

It is the main object of the present invention to provide an extruder filter replacement and backwash structure, which facilitates replacement of filters without shutting down the extruder, avoiding machine capacity loss.

It is the main object of the present invention to provide an extruder filter replacement and backwash structure, which is capable of backwashing the filters, prolonging the lifespan of the filters.

To achieve these and other objects of the present invention, an extruder filter replacement and backwash structure used in an extruder press in accordance with the present invention comprises an extruder body, a first piston set and a second piston set. The extruder body comprises a first piston hole and a second piston hole disposed in a parallel relationship, and a feed hole and a material outlet respectively located in opposing front and rear sides thereof. The first piston set comprises a first piston rod mounted in the first piston hole, and a first filter and a first grille mounted in the first piston rod. The second piston set comprises a second piston rod mounted in the second piston hole, and a second filter and a second grille mounted in the second piston rod. Subject to cross connection between the first piston rod and second piston rod and the feed hole and material outlet, the first filter or second filter can be replaced without shutting down the extruder press, or backwashed during operation of the extruder press.

### BRIEF DESCRIPTION OF THE DRAWINGS

FIG. 1 is an oblique elevational view of an extruder press configured in accordance with the present invention.

FIG. 2 is an oblique elevational view of the extruder body, first piston set and second piston set of the extruder filter replacement and backwash structure in accordance with the present invention.

FIG. 3 is an exploded view of the extruder body, first piston set and second piston set of the extruder filter replacement and backwash structure in accordance with the present invention (I).

FIG. 4 is an exploded view of the extruder body, first piston set and second piston set of the extruder filter replacement and backwash structure in accordance with the present invention (II).

FIG. 5 is a sectional view of the extruder body of the extruder filter replacement and backwash structure in accordance with the present invention (I).

FIG. 6 is a sectional view of the extruder body of the extruder filter replacement and backwash structure in accordance with the present invention (II).

FIG. 7 is a schematic sectional view of the present invention, illustrating a status of the extruder filter replacement and backwash structure during the material filtering operation (I).

FIG. 8 is a schematic sectional view of the present invention, illustrating a status of the extruder filter replacement and backwash structure during the material filtering operation (II).

FIG. 9 is a schematic sectional view of the present invention, illustrating a status of the extruder filter replacement and backwash structure during a filter replacement operation.

FIG. 10 is a schematic sectional view of the present invention, illustrating a status of the extruder filter replacement and backwash structure during a material discharge operation (I).

FIG. 11 is a schematic sectional view of the present invention, illustrating a status of the extruder filter replacement and backwash structure during a material discharge operation (II).

FIG. 12 is a schematic sectional view of a part of the present invention, illustrating a status of the first piston set during a backwashing operation therethrough.

FIG. 13 is a schematic sectional view of a part of the present invention, illustrating a status of the second piston set during a backwashing operation through the first piston set.

FIG. 14 is a schematic sectional view of a part of the present invention, illustrating a status of the first piston set during a backwashing operation through the second piston set.

FIG. 15 is a schematic sectional view of a part of the present invention, illustrating a status of the second piston set during a backwashing operation therethrough.

### DETAILED DESCRIPTION OF THE PREFERRED EMBODIMENT

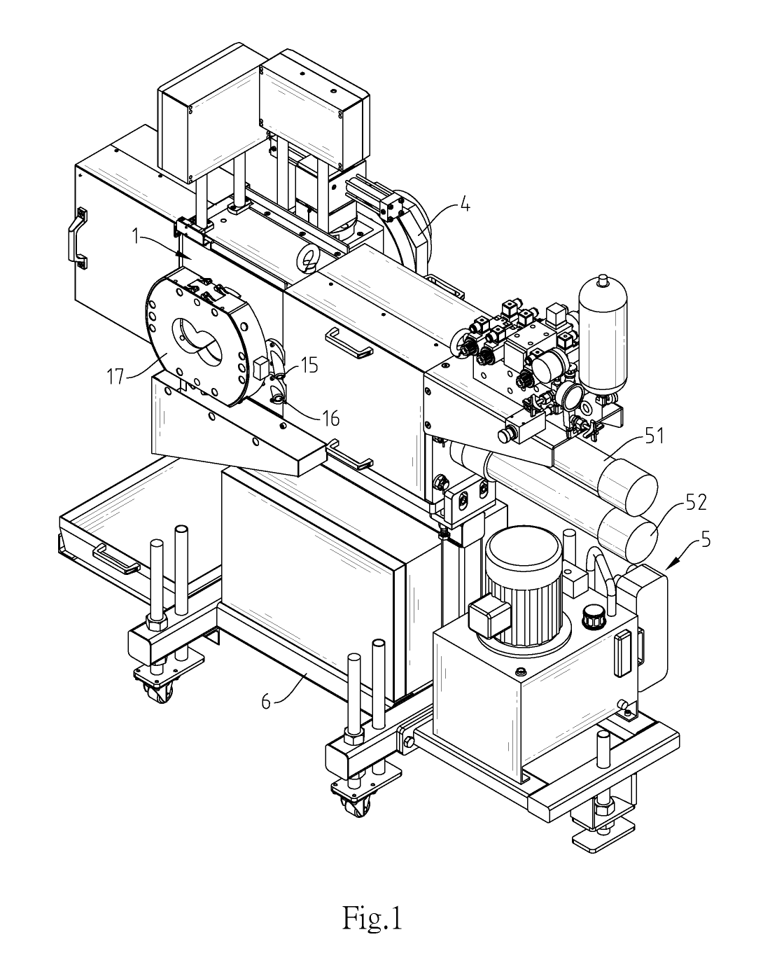

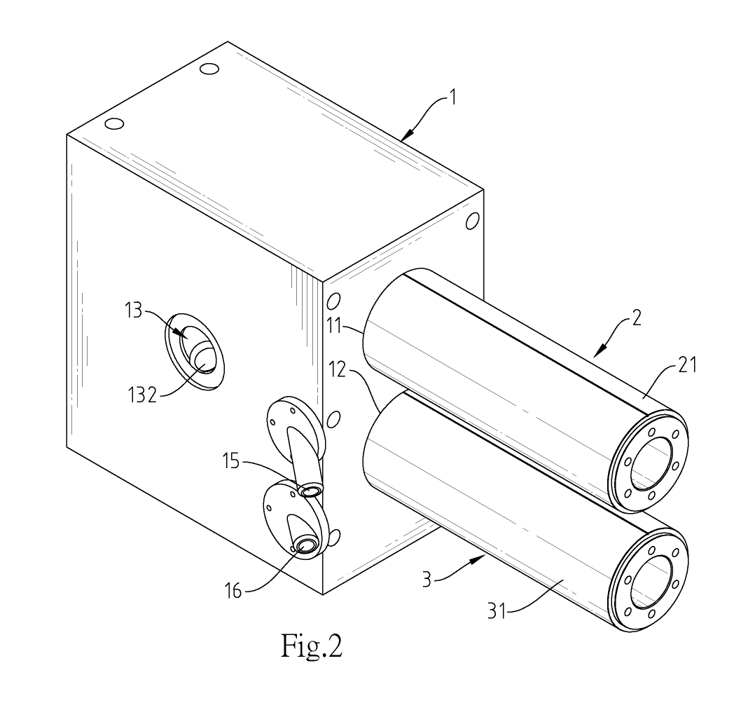

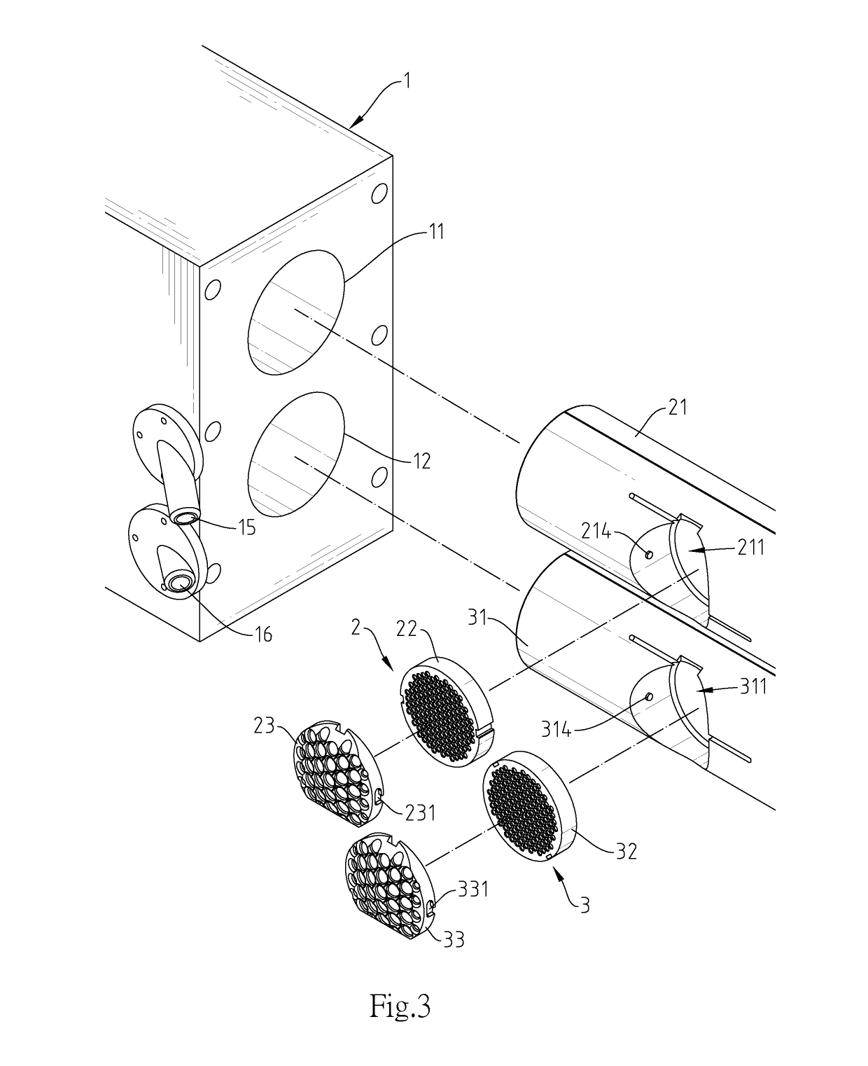

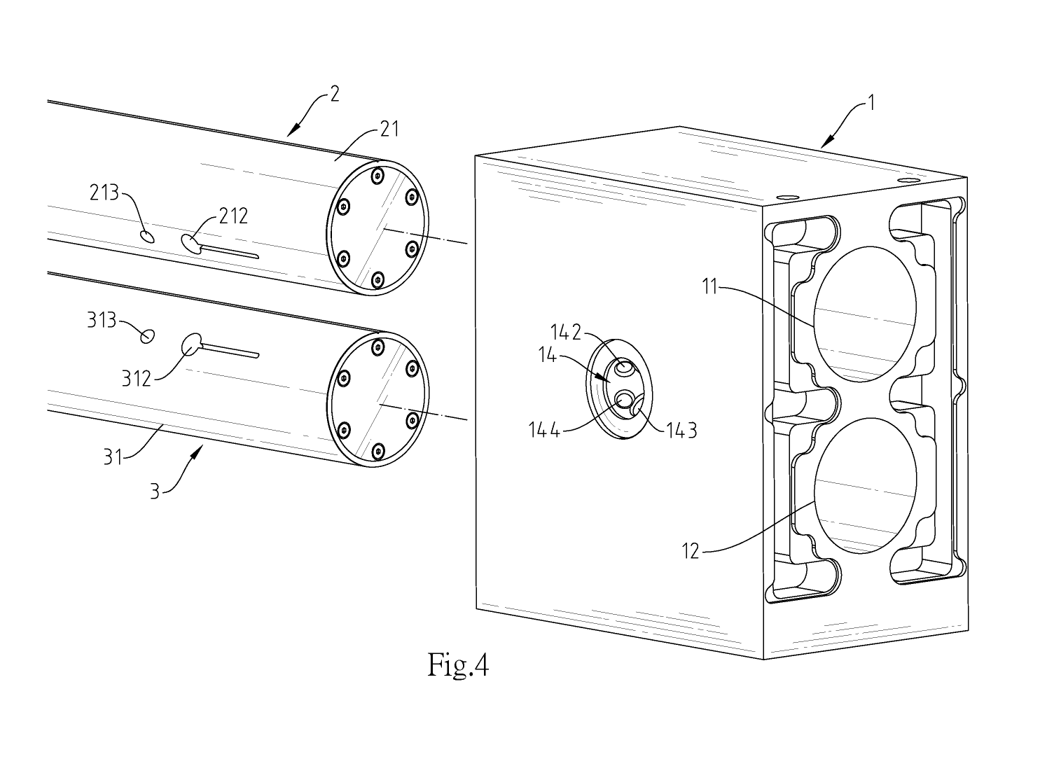

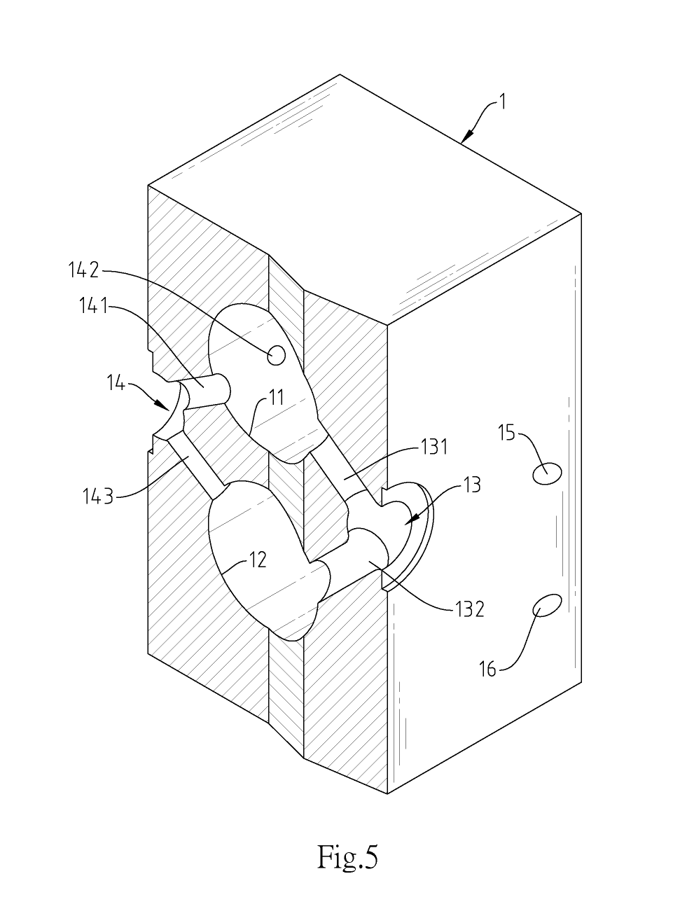

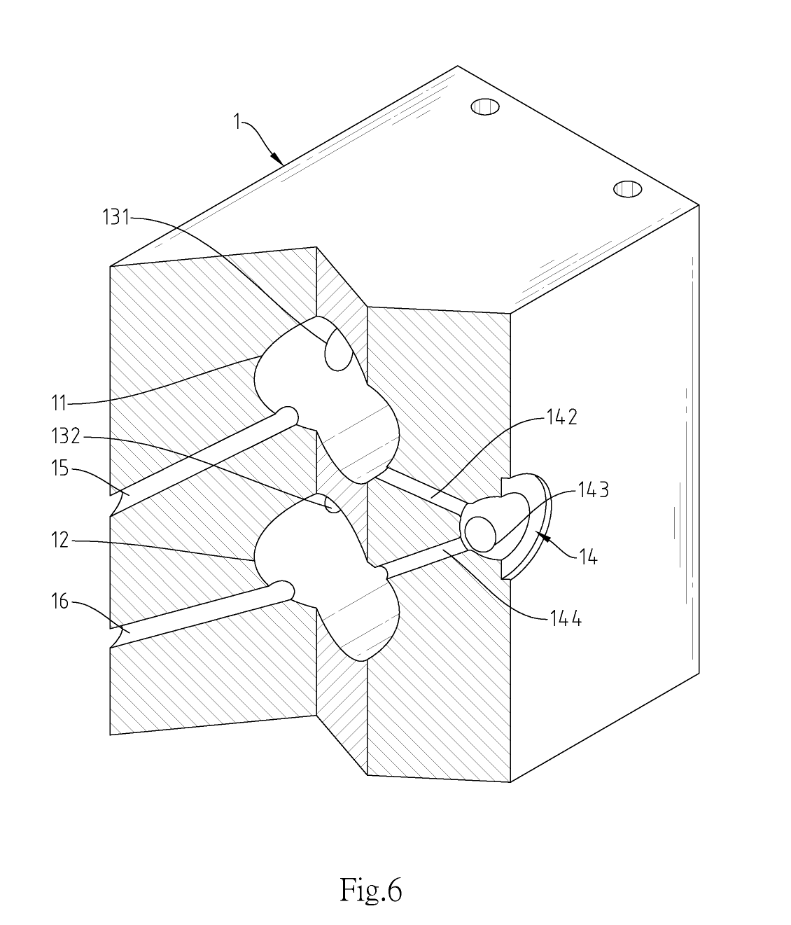

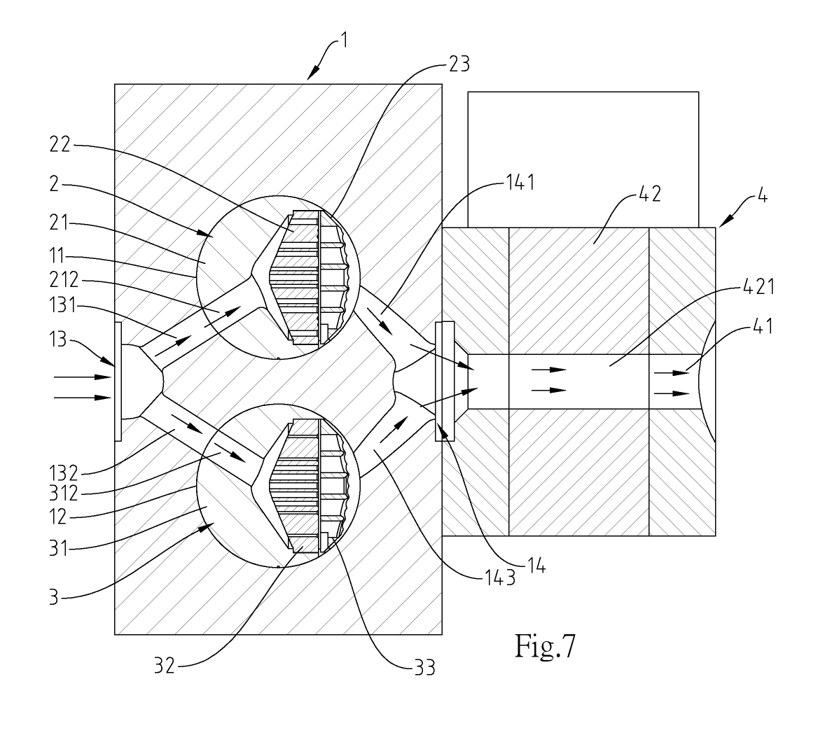

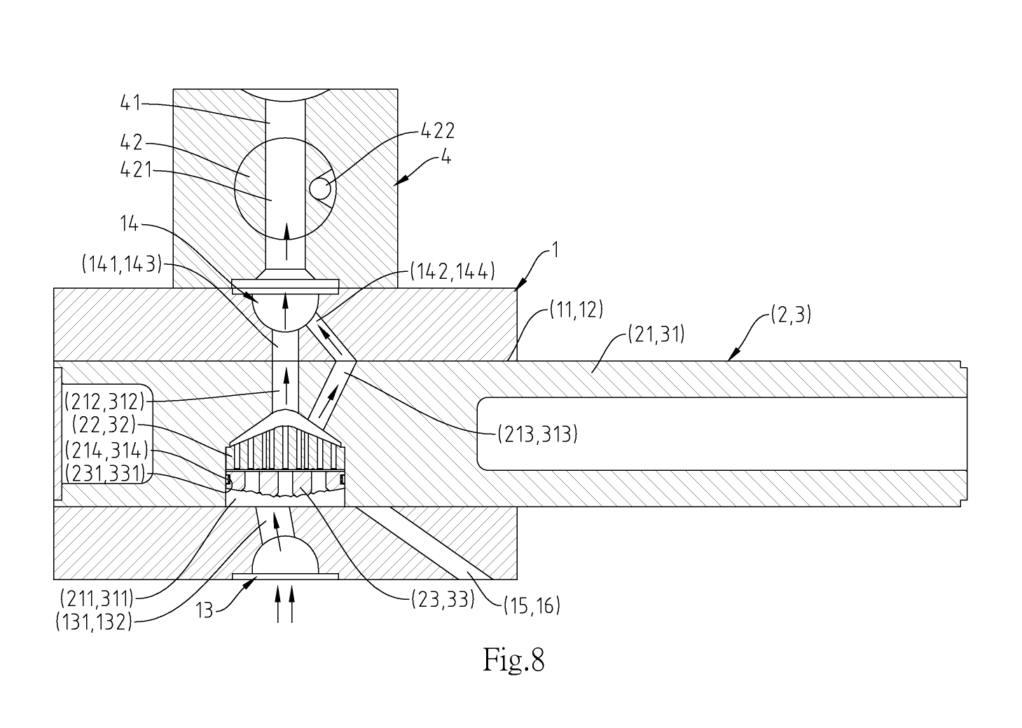

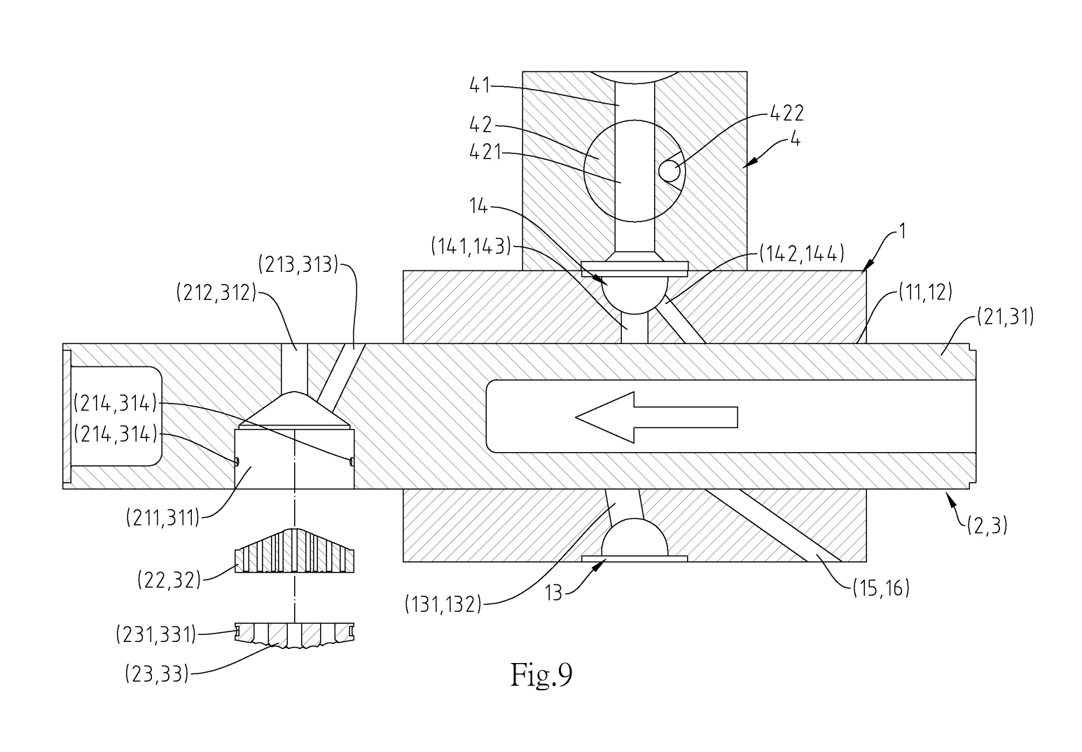

Referring to FIGS. 1-9, an extruder filter replacement and backwash structure in accordance with the present invention is shown. The extruder filter replacement and backwash structure in accordance with comprises an extruder body 1, a first piston set 2 and a second piston set 3. The extruder body 1 is mounted on the machine base 6.

The extruder body 1 comprises a first piston hole 11 and a second piston hole 12 arranged therein in a parallel relationship. Further, the first piston hole 11 and the second piston hole 12 extend through opposing left and right sides of the extruder body 1. The extruder body 1 further comprises a feed hole 13 and a material outlet 14 respectively located in opposing front and back surfaces thereof, a connection block 17 located around the feed hole 13 for the connection of a feeder (not shown), a first feed passage 131 and a second feed passage 132 defined in the feed hole 13 and respectively disposed in communication with the first piston hole 11 and the second piston hole 12, a first material outlet passage 141 and a first backwash passage 142 defined in the material outlet 14 and respectively disposed in communication with the first piston hole 11, a second material outlet passage 143 and a second backwash passage 144 defined in the material outlet 14 and respectively disposed in communication with the second piston hole 12, a first material expelling hole 15 disposed adjacent to the feed hole 13 and in communication with the first piston hole 11, and a second material expelling hole 16 disposed adjacent to the feed hole 13 and in communication with the second piston hole 12.

The first piston set 2 comprises a first piston rod 21, a first filter 22 and a first grille 23. The first piston rod 21 comprises a first filter hole 211 located in the periphery thereof at one side, and a first material passage 212 and a first backwash hole 213 located in the periphery thereof at an opposite side and respectively connected to the first filter hole 211. The first piston rod 21 is movably mounted in the first piston hole 11 of the extruder body 1 to keep the first filter hole 211 near the feed hole 13 of the extruder body 1. The first material passage 212 and the first backwash hole 213 are disposed adjacent to the material outlet 14 of the extruder body 1. Further, first locating rods 214 are symmetrically disposed in the first filter hole 211 at two opposite lateral sides. The first filter 22 and the first grille 23 are mounted in the first filter hole 211. The first grille 23 comprises a plurality of first locating holes 231 located in two opposite lateral sides thereof and respectively fastened to the first locating rods 214.

The second piston set 3 comprises a second piston rod 31, a second filter 32 and a second grille 33. The second piston rod 31 comprises a second filter hole 311 located in the periphery thereof at one side, and a second material passage 312 and a second backwash hole 313 located in the periphery thereof at an opposite side and respectively connected to the second filter hole 311. The second piston rod 31 is movably mounted in the second piston hole 12 of the extruder body 1 to keep the second filter hole 311 near the feed hole 13 of the extruder body 1. The second material passage 312 and the second backwash hole 313 are disposed adjacent to the material outlet 14 of the extruder body 1. Further, second locating rods 314 are symmetrically disposed in the second filter hole 311 at two opposite lateral sides. The second filter 32 and the second grille 33 are mounted in the second filter hole 311. The second grille 33 comprises a plurality of second locating holes 331 located in two opposite lateral sides thereof and respectively fastened to the second locating rods 314.

Further, a discharge mechanism 4 is connected to the extruder body 1 near the material outlet 14. The discharge mechanism 4 comprises a material expelling passage 41 connected to the material outlet 14, and a relief valve 42 controllable to close/open the material expelling passage 41. The relief valve 42 comprises a communication passage 421 and a relief passage 422. Further, a hydraulic press 5 is disposed at one lateral side relative to the extruder body 1. The hydraulic press 5 comprises first hydraulic cylinder 51 connected to the first piston rod 21 of the first piston set 2, and a second hydraulic cylinder 52 connected to the second piston rod 31 of the second piston set 3. Thus, the first piston rod 21 and the second piston rod 31 are controllable by the hydraulic press 5 to reciprocate in the first piston hole 11 and the second piston hole 12 respectively. Further, the hydraulic press 5 is connected with the relief valve 42 of the discharge mechanism 4 for moving the relief valve 42 between the open position and the close position.

Referring to FIGS. 1, 7 and 8 again, during a normal material filtering operation of the first piston set 2 and the second piston set 3, the hydraulic press 5 drives the relief valve 42 of the discharge mechanism 4 to the position where the communication passage 421 of the relief valve 42 is kept in communication with the material expelling passage 41, and therefore the material expelling passage 41 is opened. At the same time, the hydraulic press 5 controls the first piston rod 21 of the first piston set 2 and the second piston rod 31 of the second piston set 3 to let the first filter hole 211 of the first piston rod 21 be connected to the first feed passage 131 in the feed hole 13, the first material passage 212 and the first backwash hole 213 be respectively disposed in communication with the first material outlet passage 141 and first backwash passage 142 of the material outlet 14, the second filter hole 311 of the second piston rod 31 be connected to the second feed passage 132 of the feed hole 13, and the second material passage 312 and the second backwash hole 313 be respectively connected to the second material outlet passage 143 and the second backwash passage 144 in the material outlet 14. At this time, the first material expelling hole 15 of the extruder body 1 is blocked by the first piston rod 21 and the second material expelling hole 16 is blocked by the second piston rod 31. Thus, when the applied material is fed into the feed hole 13 of the extruder body 1, the applied material will flow through the first feed passage 131 and the second feed passage 132 into the first filter hole 211 and the second filter hole 311 and will then be filtered by the first filter 22 and the second filter 32 and then guided out of the material outlet 14 and then expelled out of the material expelling passage 41 of the discharge mechanism 4.

Referring to FIGS. 1, 3, 8 and 9 again, when changing the second filter 32 of the second piston set 3, the hydraulic press 5 is controlled to move the second piston rod 31 out of the extruder body 1, enabling the operator to replace the second filter 32 of the second piston rod 31. At this time, the first piston set 2 keeps filtering the applied material. Similarly, when changing the first filter 22 of the first piston set 2, the hydraulic press 5 is controlled to move the first piston rod 21 out of the extruder body 1, enabling the operator to replace the first filter 22 of the first piston rod 21. At this time, the second piston set 3 keeps filtering the applied material.

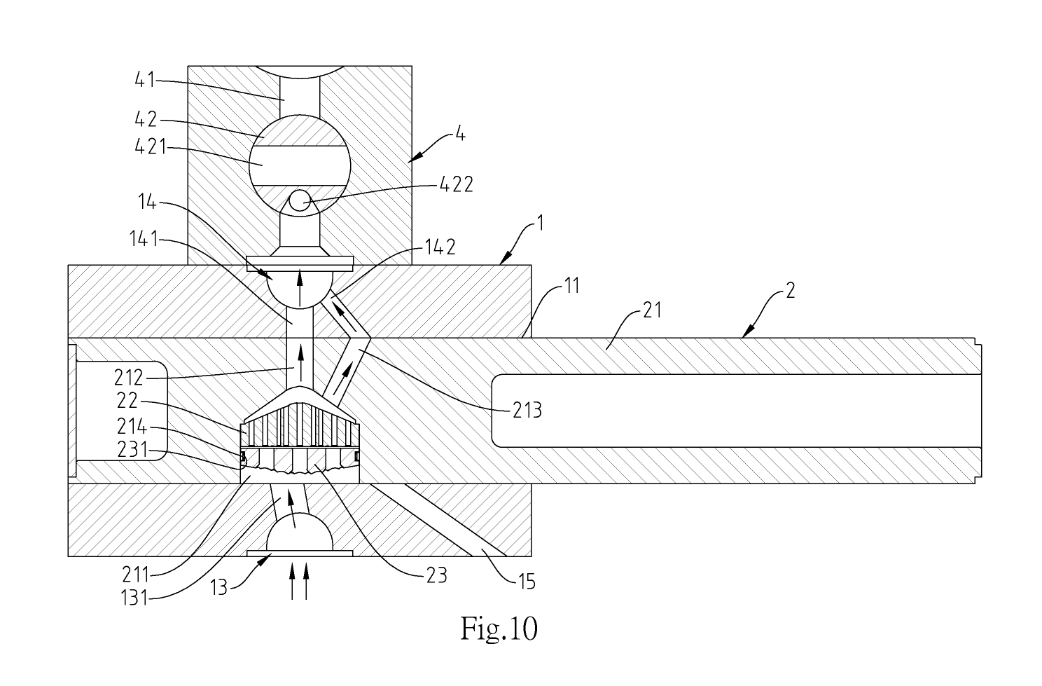

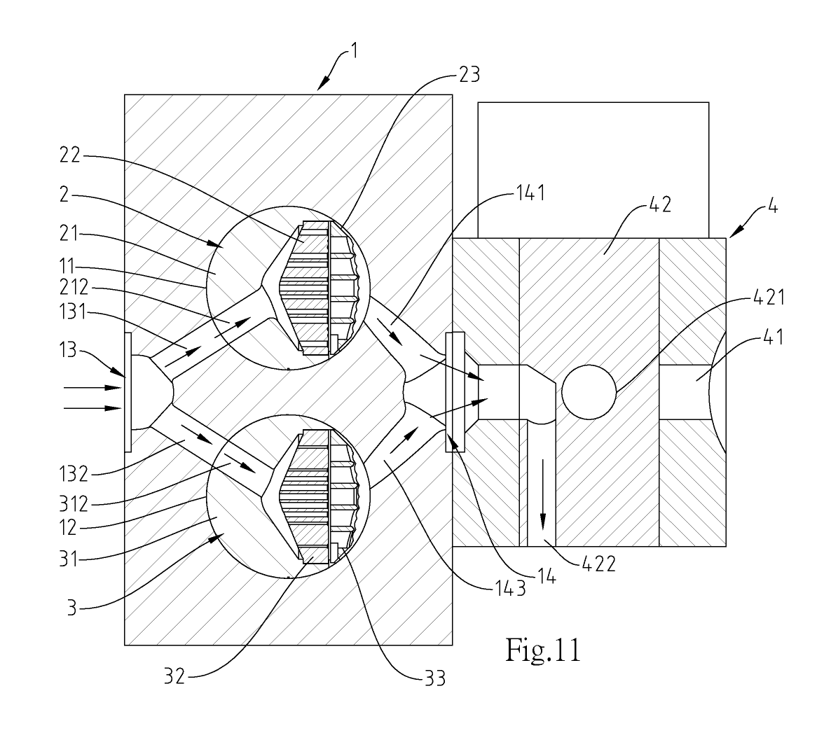

Referring to FIGS. 10 and 11 and FIG. 1 again, if the extruder press gives off an overpressure warning signal, or if the operator is unable to relieves the pressure immediately when replacing the first filter 22/second filter 32 and backwashing the first filter 22/second filter 32, the hydraulic press 5 will control the relief valve 42 at this time, moving the relief valve 42 to the position where the relief passage 422 is in communication with the material outlet 14 for discharging the applied material out of the discharge mechanism 4 through the relief passage 422 without passing through the material expelling passage 41, avoiding any manufacturing process trouble due to machine shutdown.

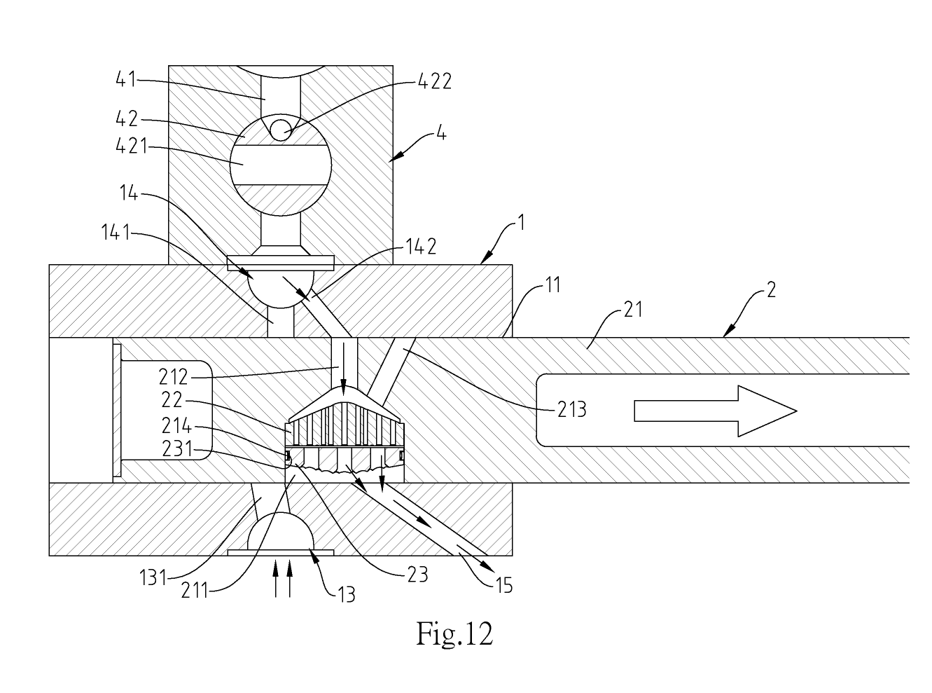

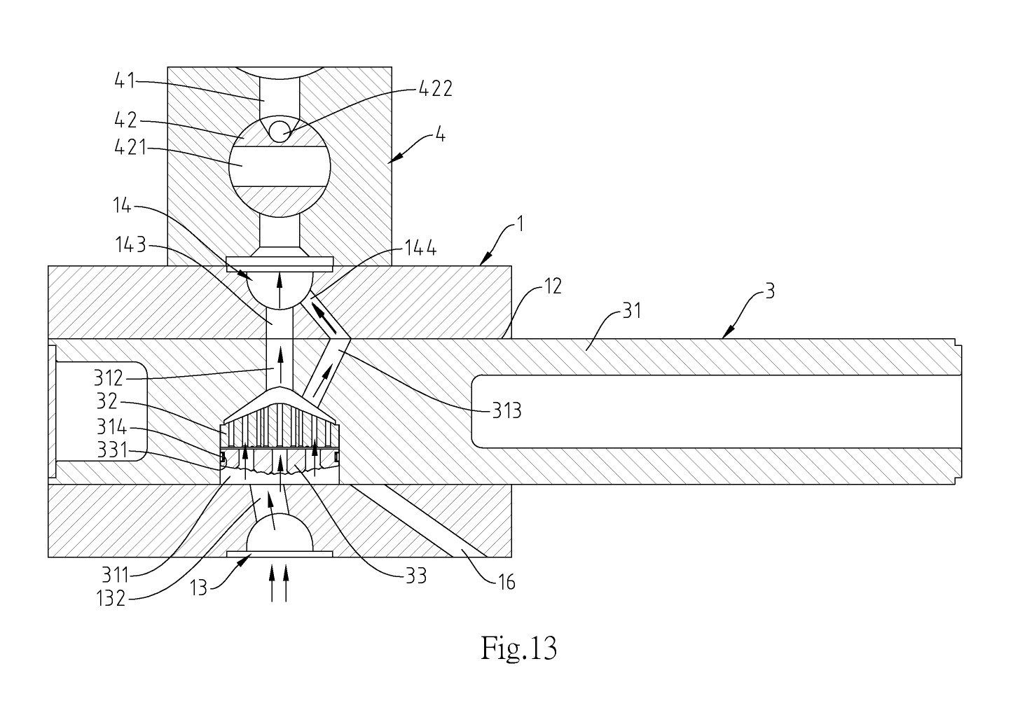

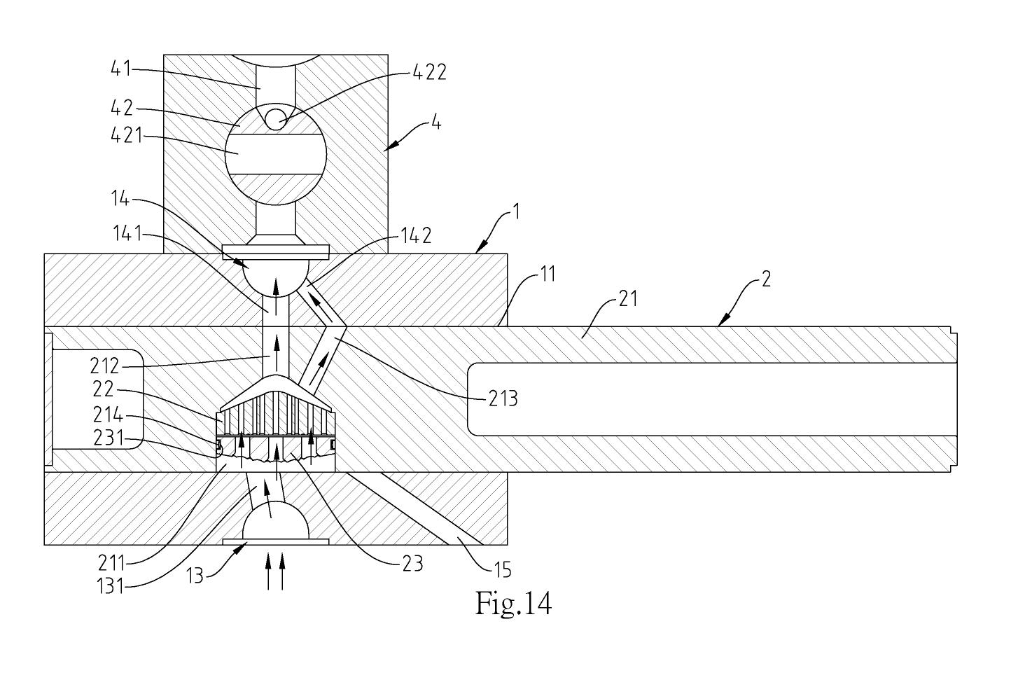

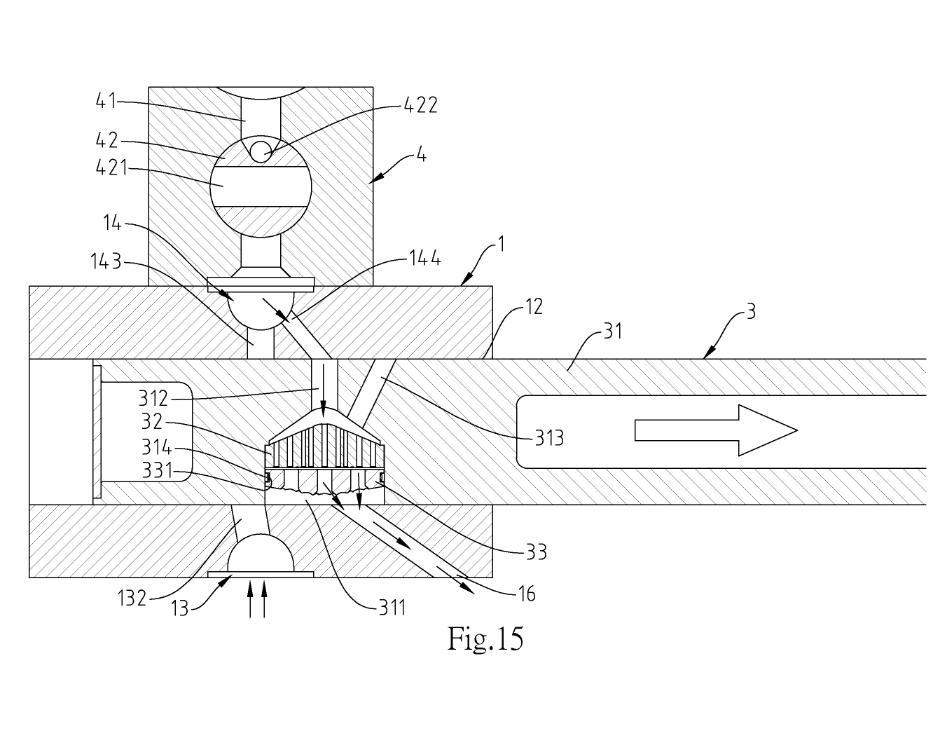

Referring to FIGS. 12-15 and FIG. 1 again, when the first piston set 2 is changed from the filtering mode to the backwash mode, the second piston set 3 is maintained in the filtering mode, enabling the hydraulic press 5 to move the relief valve 42 of the discharge mechanism 4 to the position where the material expelling passage 41 of the relief valve 42 is blocked to close the material outlet 14, and also to move the first piston rod 21 to the position where the first filter hole 211 and first material passage 212 of the first piston rod 21 are respectively kept in communication with the first material expelling hole 15 and the first backwash passage 142. Because the material outlet 14 is blocked at this time, the material filtered through the second piston set 3 will be guided through the first backwash passage 142 to the first piston rod 21 and then and then expelled out of the first material expelling hole 15. Thus, the material flows reversely through the first piston rod 21 to backwash the first filter 22. Similarly, as shown in FIGS. 14 and 15, when the second piston set 3 is changed from the filtering mode to the backwash mode, the first piston set 2 is maintained in the filtering mode, enabling the hydraulic press 5 to move the relief valve 42 of the discharge mechanism 4 to the position where the material expelling passage 41 of the relief valve 42 is blocked to close the material outlet 14, and also to move the second piston rod 31 to the position where the second filter hole 311 and second material passage 312 of the second piston rod 31 are respectively kept in communication with the second material expelling hole 16 and the second backwash passage 144. Because the material outlet 14 is blocked at this time, the material filtered through the first piston set 2 will be guided through the second backwash passage 144 to the second piston rod 31 and then and then expelled out of the second material expelling hole 16. Thus, the material flows reversely through the second piston rod 31 to backwash the second filter 32.

What the invention claimed is:

1. An extruder filter replacement and backwash structure, comprising an extruder body, a first piston set and a second piston set, wherein:
Said extruder body comprises a first piston hole and a second piston hole extended through opposing left and right sides thereof in a parallel relationship, a feed hole and a material outlet respectively located in opposing front and back surfaces thereof, a first feed passage and a second feed passage defined in said feed hole and respectively disposed in communication with said first piston hole and said second piston hole, a first material outlet passage and a first backwash passage defined in said material outlet and respectively disposed in communication with said first piston hole, a second material outlet passage and a second backwash passage defined in said material outlet and respectively disposed in communication with said second piston hole, a first material expelling hole disposed adjacent to said feed hole and in communication with said first piston hole, and a second material expelling hole disposed adjacent to said feed hole and in communication with said second piston hole;
Said first piston set comprises a first piston rod, a first filter and a first grille, said first piston rod comprising a first filter hole located in the periphery thereof at one side and a first material passage and a first backwash hole located in the periphery thereof at an opposite side and respectively connected to said first filter hole, said first piston rod being movably mounted in said first piston hole, said first filter and said first grille being mounted in said first filter hole;
Said second piston set comprises a second piston rod, a second filter and a second grille, said second piston rod comprising a second filter hole located in the periphery thereof at one side and a second material passage and a second backwash hole located in the periphery thereof at an opposite side and respectively connected to said second filter hole, said second piston rod being movably mounted in said second piston hole, said second filter and said second grille being mounted in said second filter hole.

2. The extruder filter replacement and backwash structure as claimed in claim 1, further comprising a discharge mechanism connected to said extruder body adjacent to said material outlet, said discharge mechanism comprising a material expelling passage connected to said material outlet, and a relief valve mounted in said material expelling passage, said relief valve comprising a communication passage and a relief passage.

3. The extruder filter replacement and backwash structure as claimed in claim 1, further comprising a s hydraulic press connected to one side of said extruder body, said hydraulic press comprising a first hydraulic cylinder connected to said first piston rod of said first piston set, and a second hydraulic cylinder connected to said second piston rod of said second piston set.
